(19) United States
(12) Patent Application Publication
(10) Pub. No.: US 2009/0266205 A1
(43) Pub. Date: Oct. 29, 2009

(54) Torque-Indicating Wrench

(76) Inventor: Heiao-Feng LIN, Taiping City (TW)

Correspondence Address: Dr. BANGER SHIA, 102 Lindencrest Ct., Sugar Land, TX, 77479-5201, US

(21) Appl. No.: 12/109,433

(22) Filed: Apr. 25, 2008

(51) Int. Cl. B25B 23/144; B25B 23/14

(52) U.S. Cl. 81/479; 73/862.338

(57) ABSTRACT

A wrench includes a head, a strain-vulnerable unit, at least one sensor, a handle set and a display. The strain-vulnerable unit includes a first end attached to the head, a second end at an adequate distance from the head and an aperture defined in the second end. The sensor is attached to the second end of the strain-vulnerable unit for detecting strain in the second end of the strain-vulnerable unit and sending a signal. The handle set is connected to the strain-vulnerable unit. The display is provided on the handle set and electrically connected to the sensor.

### FIELD OF INVENTION

The present invention relates to a wrench and, more particularly, to a wrench able to indicate a torque exerted thereon in a digital manner.

### BACKGROUND OF INVENTION

A conventional wrench that can indicate a torque exerted thereon in a digital manner includes a head, a handle, a sensor and a display. The handle is extended from the head. The sensor is attached to the handle near the head. The display is provided on the handle. The display is electrically connected to the sensor. When a user exerts a torque on the wrench, the sensor detects the strain in the handle near the head, and sends a signal to the display. Based on the signal, the display shows the torque. There are however problems with this conventional wrench because the sensor is close to the head. Firstly, the torque in the handle near the head detected by the sensor might be considerably different from the torque exerted on the handle by the user. Secondly, the rigidity of the head is high, and this is disadvantageous for the measurement of the torque since the measurement of the torque is based on the measurement of the strain.

The present invention is therefore intended to obviate or at least alleviate the problems encountered in prior art.

### SUMMARY OF INVENTION

It is the primary objective of the present invention to provide a wrench that can precisely indicate the value of a torque exerted thereon in a digital manner.

To achieve the foregoing objective, the wrench includes a head, a strain-vulnerable unit, at least one sensor, a handle set and a display. The strain-vulnerable unit includes a first end attached to the head, a second end at an adequate distance from the head and an aperture defined in the second end. The sensor is attached to the second end of the strain-vulnerable unit for detecting strain in the second end of the strain-vulnerable unit and sending a signal. The handle set is connected to the strain-vulnerable unit. The display is provided on the handle set and electrically connected to the sensor.

Other objectives, advantages and features of the present invention will become apparent from the following description referring to the attached drawings.

### BRIEF DESCRIPTION OF DRAWINGS

The present invention will be described via the detailed illustration of the preferred embodiment referring to the drawings.

FIG. 1 is a perspective view of a wrench that can precisely indicate a torque exerted thereon in a digital manner according to the preferred embodiment of the present invention.

FIG. 2 is an exploded view of the wrench shown in FIG. 1.

FIG. 3 is an enlarged partial view of the wrench shown in FIG. 2.

FIG. 4 is a cross-sectional view of the wrench shown in FIG. 1.

FIG. 5 is an enlarged partial view of the wrench shown in FIG. 4.

### DETAILED DESCRIPTION OF PREFERRED EMBODIMENT

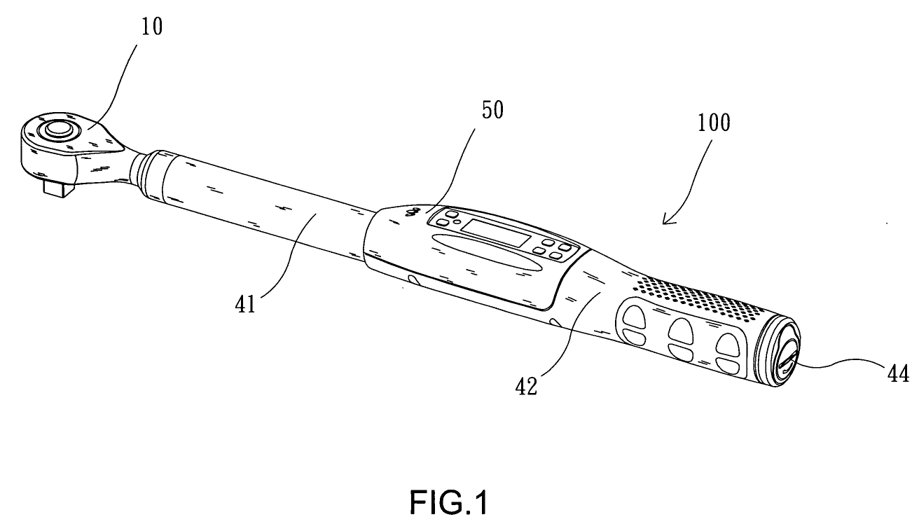

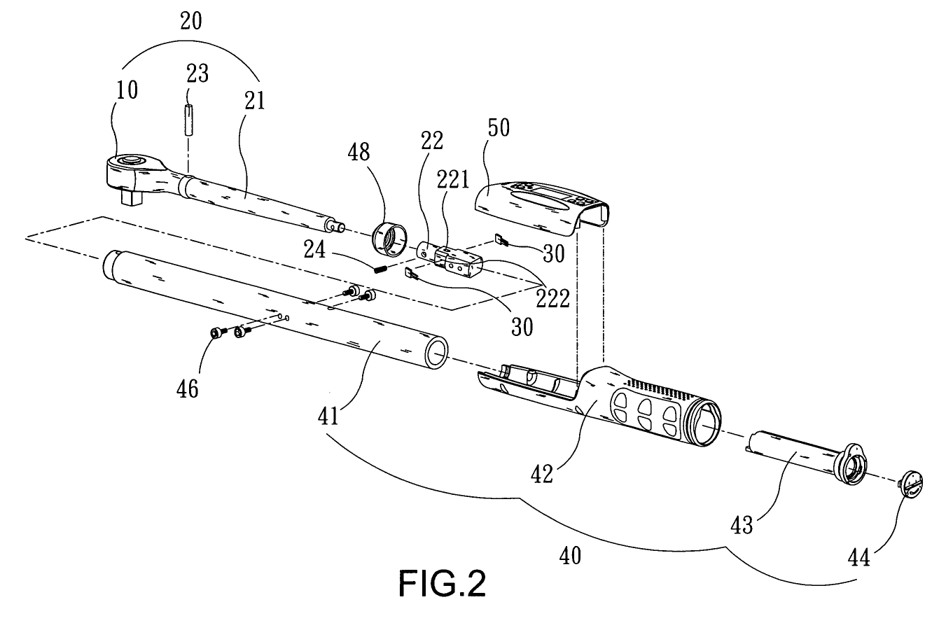

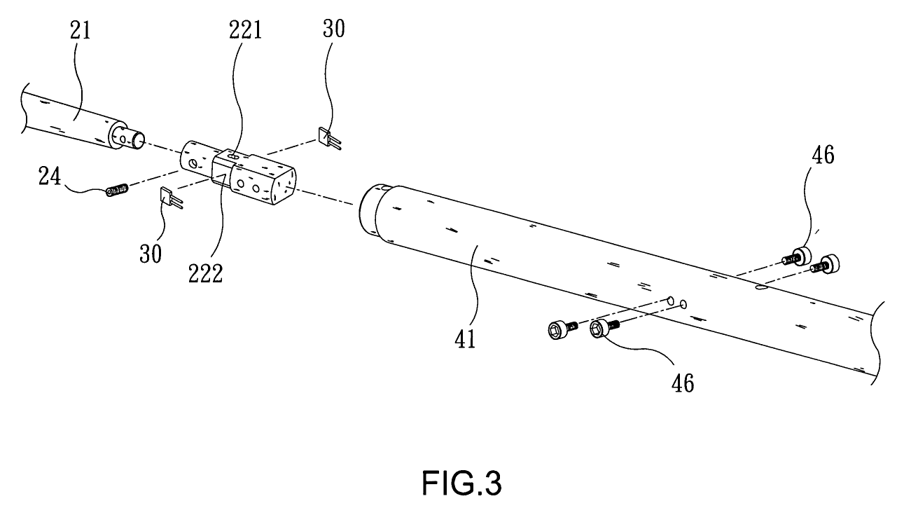

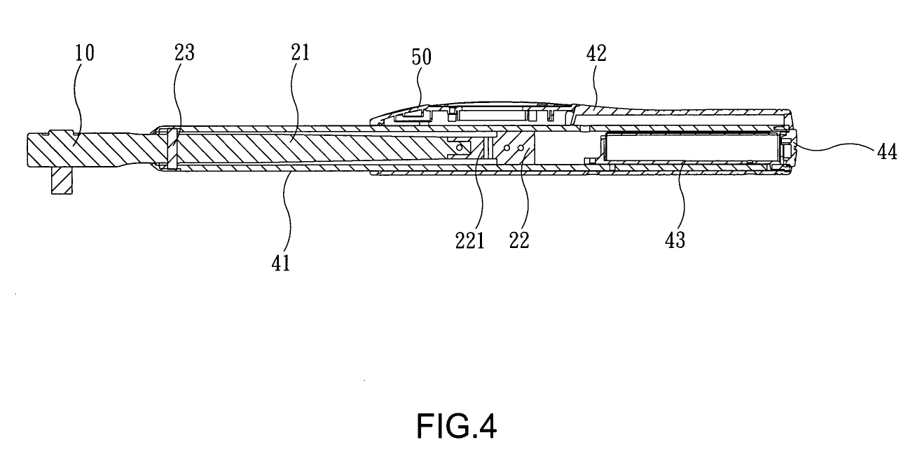

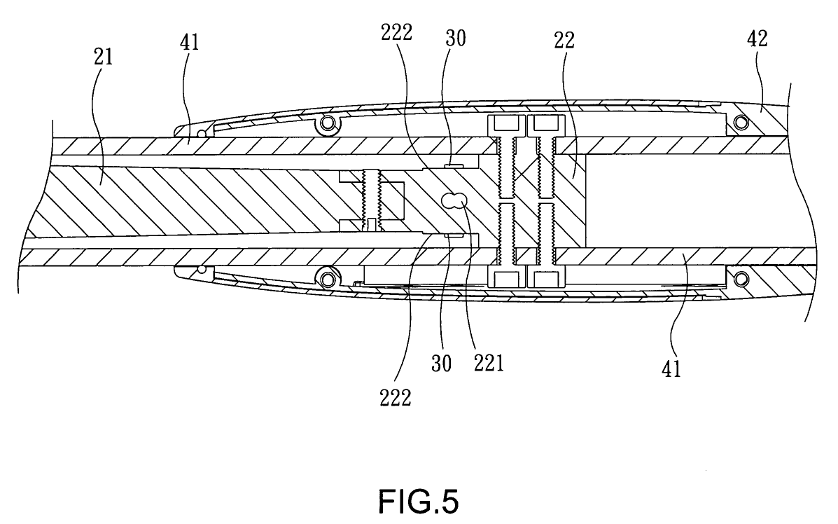

Referring to FIGS. 1 to 5, there is shown a wrench 100 that can precisely indicate a torque exerted thereon in a digital manner according to the preferred embodiment of the present invention. The wrench 100 includes a head 10, a strain-vulnerable unit 20, two sensors 30, a handle set 40 and a display 50.

The strain-vulnerable unit 20 includes a rod 21 and a carrier 22. The rod 21 is extended from the head 10. The carrier 22 includes a first section, a second section and a third section. The first section of the carrier 22 is tubular for receiving the free end of the rod 21. The first section of the carrier 22 is attached to the free end of the rod 21 with a screw 24. Alternatively, the rod 21 and the carrier 22 may be made as one piece. The carrier 22 is at an adequate distance from the head 10. The second section of the carrier 22 includes an aperture 221 therein and two flat flanks 222 thereon. The aperture 221 is 8-figured. The aperture 221 can be in any other proper shape such as a circle, a square, a triangle and a rhombus. For example, the aperture 221 may be a slot. The aperture 221 renders the second section of the carrier 22 highly deformable, i.e., strain-vulnerable.

Each of the sensors 30 is attached to a corresponding one of the flat flanks 222 of the second section of the carrier 22. The sensors 30 are strain gauges.

The handle set 40 includes a tube 41, a grip 42, a battery chamber 43 and a cover 44. The tube 41 is provided around the rod 21 and the carrier 22. The tube 41 is attached to the rod 21 with a pin 23. The tube 41 is attached to the carrier 22 with four screws 46. The grip 42 is provided around the tube 41. The battery chamber 43 is disposed in the grip 42. Batteries can be disposed in the battery chamber 43. The cover 44 can be engaged with the battery chamber 43, thus keeping the batteries in the battery chamber 44.

The display 50 is provided on the tube 41 and the grip 42. A ring 48 is used to join the display 50 to the grip 42. The display 50 is connected to the sensors 30 electrically.

When a user holds the grip 42 and exerts a torque on the wrench 100, there is strain and stress in the carrier 22. Because of the aperture 221, the carrier 22 becomes a point of concentrated stress and is vulnerable to the strain. The strain in the carrier 22 is considerable and can precisely be sensed with the sensors 30. Hence, the torque transferred to the carrier 22 can precisely be measured by the sensors and shown on the display 50. Moreover, the carrier 22 is far from the head 10 but close to the grip 42 so that the torque transferred to the carrier 22 is substantially equal to the torque exerted by the user.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A wrench comprising:
a head;
a strain-vulnerable unit comprising a first end attached to the head, a second end at an adequate distance from the head and an aperture defined in the second end;
at least one sensor attached to the second end of the strain-vulnerable unit for detecting strain in the second end of the strain-vulnerable unit and sending a signal;
a handle set connected to the strain-vulnerable unit; and
a display provided on the handle set and electrically connected to the sensor.

2. The wrench according to claim 1, wherein the strain-vulnerable unit comprises a rod extended from the head and a carrier attached to the rod to carry the sensor.

3. The wrench according to claim 1, wherein the rod and the carrier are made as one piece.

4. The wrench according to claim 1, wherein the rod is inserted in the carrier.

5. The wrench according to claim 2 comprising a pin for securing the handle set to the rod.

6. The wrench according to claim 1, wherein the aperture is 8-figured.

7. The wrench according to claim 1, wherein the aperture is in a shape selected from a group consisting of a circle, a square, a triangle and a rhombus.
